(19) United States
(12) Patent Application Publication
(10) Pub. No.: US 2012/0119501 A1
(43) Pub. Date: May 17, 2012

(54) System and Method for Fluid Flow Power Generation

(76) Inventor: Christopher Yeomans, Redditch (GB)

(21) Appl. No.: 13/377,266

(22) PCT Filed: Feb. 16, 2010
(86) PCT No.: PCT/GB2010/000275

§ 371 Date: Feb. 1, 2012

(30) Foreign Application Priority Data
Jun. 12, 2009 (GB) 0910118.9

(51) Int. Cl. F03B 13/00; F03B 9/00

(52) U.S. Cl. 290/54

(57) ABSTRACT

A system and method for fluid flow power generation is described which can provide a low cost and efficient means to generate electricity from fluid flow. The system comprises a flexible membrane belt which is mounted upon two moveable able cylindrical elements linked to a power generation means. The system comprises a support structure which can be placed in a river or stream such that the rotating cylinders are maintained above the fluid flow and wherein the lower moving part of the membrane makes contact with the moving fluid. The membrane comprises an array of pockets which project into the moving fluid and which are dragged along by the moving fluid thereby causing the moving membrane to rotate the cylinders. One or both cylinders are coupled to a hydraulic and or mechanical means for power generation. The system supports may comprise a system of floats which serve to maintain the membrane at the optimum level in the moving fluid as the water level of the river or stream changes. In alternative embodiments, the invention provides a self-contained power generation system for marine vessels as well as the basis for a new offshore tidal power generation system.

### BACKGROUND OF THE INVENTION

The invention relates to a system and method for fluid flow power generation. More particularly, it relates to a system and method for generating electric power from surface fluid flow in which a flexible membrane belt comprising an array of pockets or paddles is dragged along by a moving fluid such as a river or stream. The membrane is mounted on two moveable cylindrical elements or cylinders which are caused to rotate by the movement of the membrane and wherein at least one cylinder is coupled to a mechanical or hydraulic transmission system to drive an electric generator.

The invention is particularly addressed towards the creation of a new and more efficient means of electric power generation which optimizes the contact of a flexible membrane, comprising an array of pockets and or paddles, with the surface of a moving fluid wherein the moving fluid drags the flexible belt along at the speed of the fluid flow and thus causes the cylinders to rotate and wherein the mechanical rotation drives a mechanical transmission to drive an electric generator, or it drives a hydraulic fluid pump which transfers fluid to a second hydraulic pump to drive an electric generator. Moreover, in one embodiment the membrane belt and cylinder system is integrated with, and moveable along the vertical axis of, a vertical support structure and further integrated with an array of floats such that the cylinder and membrane system is caused to move with the rising or falling water level and thereby maintain the membrane belt and pockets at an optimum position with regard to the fluid surface.

Generally, water wheels have been used to generate power to drive mechanical systems for thousands of years. Such wheels are either overshot waterwheels in which water falls under gravity against the paddles of the wheel, or undershot waterwheels where a wheel is placed in the surface of a moving river and is caused to turn. In the case of overshot waterwheels, these may only be placed at a location where there is a significant change in level of the river or stream. Conversely, undershot water wheels are not very efficient because the wheel paddles are fixed and their orientation relative to the fluid flow is changing as the wheel rotates.

Unlike other forms of renewable power generation, such as wind turbines which are only efficient power generation systems over a predetermined range of wind speeds, rivers and streams offer significant untapped potential for power generation as they generally offer a constant fluid flow 24 hours per day, all the year round.

In other areas of application, pleasure boats and yachts require power for on board equipment particularly when they are sailing or at anchor in a moving current or anchored off shore in a tidal flow zone. Today, few systems are available which offer a versatile power generation system which can derive power from the river or tide.

Furthermore, the offshore tidal flow zones offer substantial opportunities for new and improved systems for electric power generation.

Further to the limitations of existing methods for fluid flow power generation, and so far as is known, no optimum system and method for fluid flow power generation is presently available which is directed towards the specific needs of this problem area as outlined.

### OBJECTS OF THE INVENTION

Accordingly, it is an object of the present invention to provide an improved system and method for fluid-flow power generation in which a moveable membrane belt, comprising an array of pockets and or paddles, is mounted upon two moveable cylindrical elements linked to an electric power generation means and wherein the system is held above a moving fluid such that the pockets and or paddles project into the moving fluid thereby causing the membrane belt to be dragged along by the fluid which rotates the cylinders and generates power.

It is a further object of one embodiment of the present invention to provide a system and method for fluid-flow power generation in which a moveable membrane belt, comprising an array of pockets and or paddles, is mounted upon two moveable cylindrical elements and wherein the complete system is integrated with a support frame and wherein the support frame comprises means to be held at an optimum level relative to the level of the fluid.

It is a further object of one embodiment of the present invention to provide a system and method for fluid-flow power generation in which a moveable membrane belt, comprising an array of pockets and or paddles, is mounted upon two moveable cylindrical elements and wherein the said belt and cylindrical elements are integrated with a support frame and wherein the support frame comprises one or more flotation elements and wherein the said frame is moveably mounted on a vertical support such that the belt can be maintained at an optimum height relative to the fluid level.

It is a further object of one embodiment of the present invention to provide a system and method for fluid-flow power generation in which a moveable membrane belt, comprising an array of pockets and or paddles, is mounted upon two moveable cylindrical elements and wherein the said belt and cylindrical elements are integrated with a support frame and wherein the support frame comprises one or more flotation elements which serve to maintain the said pockets and or paddles of the belt at an optimum level in the fluid and wherein the system is anchored to provide relative movement between the fluid flow and the belt pockets and or paddles.

It is a further object of one embodiment of the present invention to provide a system and method for fluid-flow power generation in which a moveable membrane belt comprising an array of pockets and or paddles is mounted on two moveable cylindrical support elements and wherein the total system is integrated with a support structure and wherein the structure comprises a lower guide structure, or race, directly below the flexible membrane belt to provide a channel for the moving fluid.

It is a further object of one embodiment of the present invention to provide a system and method for fluid-flow power generation in which a moveable membrane belt comprising an array of pockets and or paddles is mounted on two moveable cylindrical support elements and wherein the total system is integrated with a support structure and wherein the structure comprises a lower guide structure directly below the flexible membrane belt to provide a channel for the moving fluid which further comprises opening guides where the fluid enters the channel to increase the fluid flow rate through the channel.

It is a further object of one embodiment of the present invention to provide a self-contained unit for fluid-flow power generation in which a moveable membrane belt comprising an array of pockets and or paddles is mounted on two moveable cylindrical support elements wherein one or both cylindrical elements are integrated with a power generation means and wherein the total system is integrated with a support structure which is mounted on flotation elements or comprises buoyancy elements and or comprises a hydrodynamic design to optimise movement through the water and which may be towed behind a marine vessel and thereby provide power to the marine vessel.

It is a further object of one embodiment of the present invention to provide a self-contained unit for fluid-flow power generation suitable for a marine vessel in which a moveable membrane belt comprising an array of pockets and or paddles is mounted on two moveable cylindrical support elements wherein one or both cylindrical elements are integrated with a hydraulic transmission which is linked via a hydraulic connection to an electric power generation means mounted on the marine vessel and wherein the total system is integrated with a support structure which is mounted on floatation elements or which comprises internal buoyancy elements and which may be towed behind a marine vessel.

It is a further object of one embodiment of the present invention to provide a self-contained unit for fluid-flow power generation suitable for a marine vessel in which a moveable membrane belt comprising an array of pockets and or paddles is mounted on two moveable cylindrical support elements wherein one or both cylindrical elements are integrated with a geared transmission, or with a hydraulic transmission which is linked via a hydraulic connection to an electric power generation means mounted on the marine vessel, and wherein the total system is integrated into a highly hydrodynamic-shaped support structure which has optimum buoyancy to maintain the movement of the structure through the water and which may be towed behind a marine vessel.

It is a further object of one embodiment of the present invention to provide a self-contained unit for fluid-flow power generation suitable for a marine vessel in which one or more moveable membrane belts comprising an array of pockets and or paddles is each mounted on two moveable cylindrical support elements wherein one or both cylindrical elements are integrated with a geared transmission, or with a hydraulic transmission which is linked via a hydraulic connection to an electric power generation means mounted on the marine vessel, and wherein the total system is integrated into a highly hydrodynamic-shaped support structure which has optimum buoyancy to maintain the movement of the structure through the water and which may be towed behind a marine vessel, and wherein the one or more moveable membrane belts each make contact with the water via a central channel within the hydrodynamic-shaped structure through which water flows as the structure is dragged through the water and wherein the flow of water through the central channel causes the one or more belts to move and thus generate power.

It is a further object of one embodiment of the present invention to provide a self-contained unit for fluid-flow power generation suitable for a marine vessel in which a moveable membrane belt comprising an array of pockets and or paddles is mounted on two moveable cylindrical support elements wherein one or both cylindrical elements are integrated with a mechanical transmission which drives an electric generator, or is integrated with a hydraulic transmission which is linked via a hydraulic connection to an electric power generation means and wherein the total system is integrated with the hull of the marine vessel and thereby generates power as the vessel moves relative to the fluid.

It is a further object of one embodiment of the present invention to provide a self-contained unit for fluid-flow power generation for marine vessels which comprises a moveable membrane belt comprising an array of pockets and or paddles mounted on two moveable elements wherein one or both elements are integrated with a hydraulic transmission which is linked to an electric power generation means or is integrated with a mechanical transmission and wherein the total system generates power as the membrane belt moves relative to the fluid and wherein the system can generate power as the belt moves in either a forward or a backward direction.

It is a further object of one embodiment of the present invention to provide a self-contained unit for fluid-flow power generation which comprises one or more moveable membrane belts each comprising an array of pockets and or paddles mounted on two moveable elements wherein one or both moveable elements are integrated with a hydraulic transmission or a geared transmission which is linked to an electric power generation means and wherein the total system generates power as the membrane belt moves relative to the fluid and wherein the system can generate power as one or more belts is caused to move as the system is dragged through the water and wherein the hydrodynamic structure comprises hydrodynamic fins which serve to maintain the system at the optimum depth and attitude in the water.

It is a further object of one embodiment of the present invention to provide a self-contained unit for fluid-flow power generation suitable for being located in a tidal zone in which a moveable membrane belt comprising an array of pockets and or paddles is mounted on two or more moveable cylindrical support elements wherein one or more cylindrical elements are integrated with a hydraulic transmission which is linked via a hydraulic connection to an electric power generation means mounted onshore and wherein the total system is integrated with a support structure which is mounted on flotation elements or which comprises buoyancy elements and which may be anchored in the said tidal zone.

It is a further object of one embodiment of the present invention to provide a self-contained unit for fluid-flow power generation suitable for being located in a tidal zone in which a moveable membrane belt comprising an array of pockets and or paddles is mounted on two or more moveable cylindrical support elements wherein one or more cylindrical elements are integrated with a hydraulic transmission which is linked via a hydraulic connection to an electric power generation means mounted onshore, or is integrated with a mechanical transmission which drives an electric generator, and wherein the total system is integrated into a tidal barrier structure wherein an incoming tide turns an upper belt in the structure and an outgoing tide turns a lower belt in the structure and wherein one-way valves maintain the direction of the fluid flow in the lower part of the structure.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for fluid flow power generation which is highly suited to the market need for a highly efficient means to generate power from rivers and streams and in tidal flow areas and in offshore currents such as riptides and for a new and improved means of power generation for sailing boats and other marine craft.

In different configurations, the invention comprises a moveable flexible membrane belt which is mounted on two moveable cylindrical supports which are integrated together by way of a support structure and free to rotate around an axis tangential to the direction of movement of the belt and which are linked via a hydraulic transmission or a geared transmission to a power generation means. The belt comprises pockets and or paddles and the belt and cylinder structure is maintained above the surface of the fluid by way of a flotation means such that the pockets and or paddles project into the fluid surface and are dragged along by the fluid flow thereby causing the belt to rotate the cylinders.

One or both cylinders are connected by way of a hydraulic transmission or a geared transmission to a power generation means such that the energy of the moving fluid is transferred into movement of the belt to drive an electric generator.

The belt may comprise a flexible membrane of impermeable material or a sequence of connected rigid plates which carry an array of pockets and or paddles. A guide channel structure comprising opening guide vanes is integrated with the support structure to provide a closed channel for the fluid directly below the belt under the water to improve the power transfer between the fluid flow and the belt. The guide vanes serve to increase the fluid flow beneath the belt.

The system may be integrated into a hydrodynamic-shaped structure and towed behind a marine vessel to provide a means of power generation.

The system may be integrated into a tidal zone structure and generate power as the tide comes in or goes out.

The system may be integrated into a hydrodynamic-shaped structure comprising material of low density and be anchored to the seabed such that the structure is positioned directly in an offshore current or rip current. This application makes possible the placement of the system at the optimum depth. Electrical cables or hydraulic lines transfer the power generated to onshore equipment.

Other objects and features of the present invention will become apparent from the following detailed description considered in connection with the accompanying drawings, which disclose one key embodiment of the invention. It is to be understood, however, that the drawings are designed for the purpose of illustration only and that the particular descriptions of the fluid flow power generation system for the river application and the separate marine vessel application are given by way of example only and do not limit the scope of the invention.

### BRIEF DESCRIPTION OF THE DRAWINGS

FIG. 1A illustrates one embodiment of the membrane belt and cylindrical elements and support structure.

FIG. 1B illustrates one embodiment of a self-tensioning support structure.

FIG. 2 illustrates one embodiment of the adjustable level mechanism.

FIG. 3 illustrates one embodiment of a hydrodynamic-shaped structure suitable for a marine vessel application.

FIG. 4 illustrates one embodiment of a self-contained power generation system suitable for a marine vessel application.

FIG. 5 illustrates one embodiment of the bulkhead mechanics.

FIG. 6 illustrates one embodiment of a tidal flow application.

### DESCRIPTION OF A PREFERRED EMBODIMENT

The following description makes full reference to the features of the different embodiments as outlined in the objects of the invention.

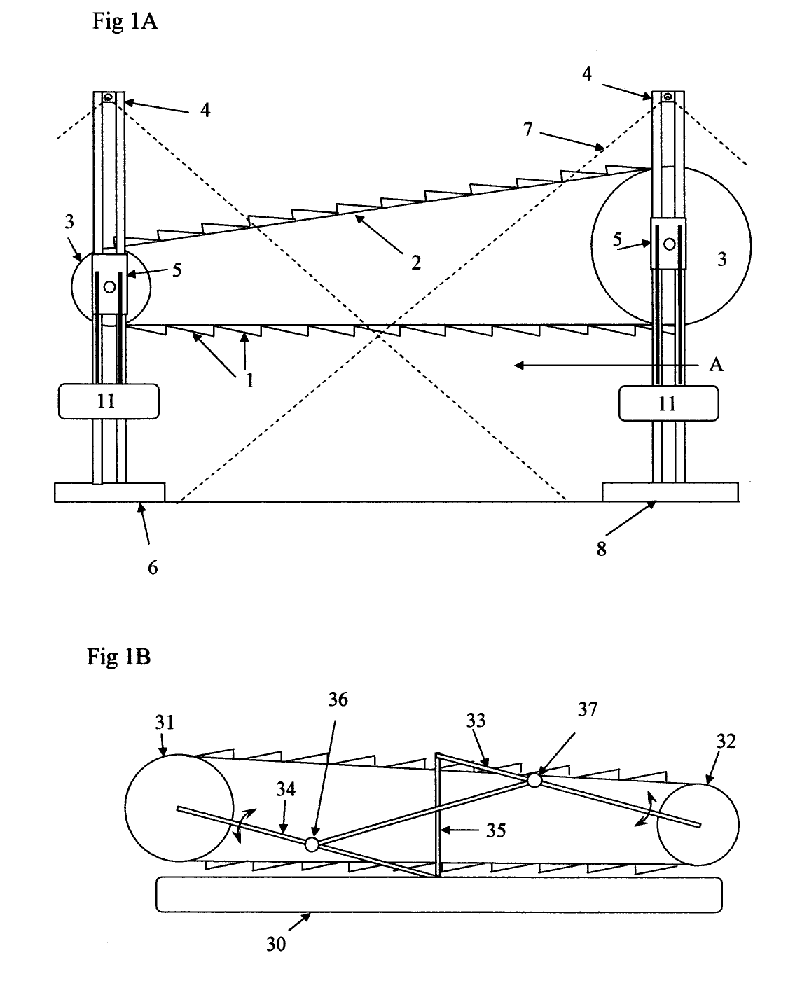

Referring now in detail to the drawings and in particular FIG. 1A thereof, therein illustrated is a schematic showing an example of a flexible membrane belt (2) comprising pockets (1) according to a first embodiment of the invention mounted on two cylindrical elements (3). The cylindrical elements may be of identical or different diameters but to generate the most power, structural design choices maintain the lower part of the belt in optimum contact with the fluid flow.

The two cylindrical elements are supported on two base structures (6,8) of appropriate density such as concrete which may be placed on a river bed or other submerged structure. Each of the base structures comprise vertical supports (4) which each carry a moveable element (5) which enables each cylindrical element to move up or down along a vertical axis and thereby maintain the lower part of the belt at an optimum height with respect to the fluid surface. The optimum height is determined by the optimum power generation of the system where the pockets of the belt are immersed into the moving fluid thereby minimising resistance to the belt motion.

A flotation structure (11) maintains the cylindrical elements at the optimum height above the moving fluid.

At the top of the vertical supports is shown a hole in the linking structure through which one or more fixing lines (7) can be attached. The other end of each fixing line can be fixed to the river or stream bed or alternatively, the system can be tethered to the banks of a river or stream. This also makes possible the deployment of this power generation means in places where the river is very deep or unsuitable for the supports (6,8) wherein the fixing lines can serve to provide a means to anchor the structure.

In FIG. 1B is shown an alternative support structure. In this configuration the system is supported by a flotation system (30) which runs the length of the structure. This is made of low density material and may comprise two structures either side of the cylinder belt system. In other embodiments there may be a submerged guide plate or race and or the flotation elements may comprise opening vanes to guide the water into the channel directly below the belt. The figure shows the two cylindrical elements (31, 32) and a structure with a vertical support (35) fixed to the flotation system (30). The two cylindrical elements are attached to the vertical support by way of two rigid moveable support arms (33,34). It is to be understood that the same support structure exists both sides of the belt system. This structure serves to maintain the tension on the belt. The two support arms are connected via a rod linking the two axis points (36,37). In different embodiments the same cantilevered structure can be integrated with a support structure which is positioned on the riverbed. In all embodiments the system serves to maintain the profile of the structure lower in the water and limits the complexity of the moving parts. In this arrangement, the cylindrical elements are allowed to move up and down with changing water levels while maintaining the inter-axial separation of the cylinders.

This design is far simpler and cheaper to produce and to set up. It also limits the amount by which the machine needs to be calibrated upon installation to ensure an accurate rotation.

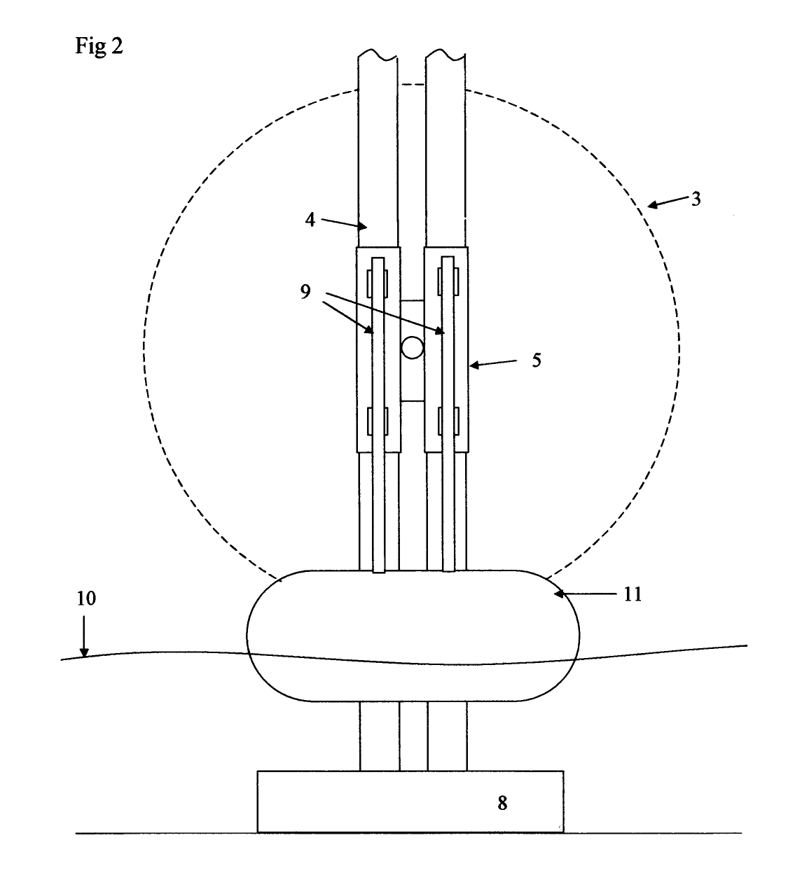

Referring now in detail to FIG. 2 is shown details of the flotation system used to maintain the structure at the optimum height in the moving fluid. The system maintains its optimum height through a flotation means (11) linked to the moveable element (5). The flotation device (11) comprises sufficient material of low density to maintain the lower part of the belt at the said optimum height relative to the surface of the fluid.

Guide supports (9) are fixed to the flotation device (11) and integrated with the moveable element (5) which supports each cylindrical element (3) allowing the cylindrical element to move in a vertical direction up and down along the vertical supports (4). The flotation device (11) floats in the fluid (10) and thus the cylindrical elements and belt system is maintained at an optimum height relative to the fluid surface.

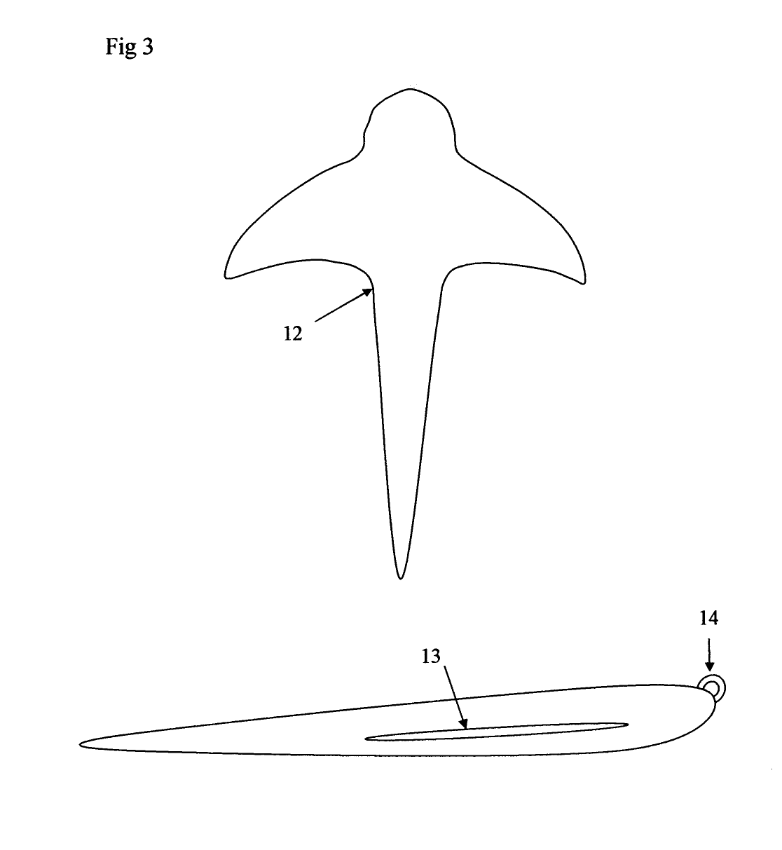

The power generation system and method according to the invention has ideal application to form the basis for a highly efficient power generation device for marine vessels. With reference now to FIG. 3 is shown a hydrodynamic design for the outer structure of one embodiment of a marine vessel power generation system according to the invention. The image shows a structure (12) similar to the shape of a ray. This design is ideal to be dragged through the water by a marine craft. The design further comprises two wing structures (13) which may be flat or which may comprise hydrodynamic curvature to maintain the structure at an optimum orientation and or depth. The structure is constructed of a material of appropriate low density so that the structure is held at the optimum depth in the water. In different embodiments, the buoyancy of the structure may be achieved by constructing pockets of low density material in different parts of the structure. A ring (14) is provided to which the structure can be attached for towing behind a marine vessel.

In a separate embodiment, the hydrodynamic-shaped structure may comprise low density material and thereby be buoyant, and be tethered or anchored to the seabed at the optimum depth in a rip current. In this way the power generation system can generate power from submerged currents. In different embodiments the power generated can be used to power lights on the structure which thus renders the structure useful for undersea lighting applications for aesthetic or for practical purposes such as navigation or to warn of undersea dangers. Electric cables or hydraulic lines can connect the power generation system to equipment on shore.

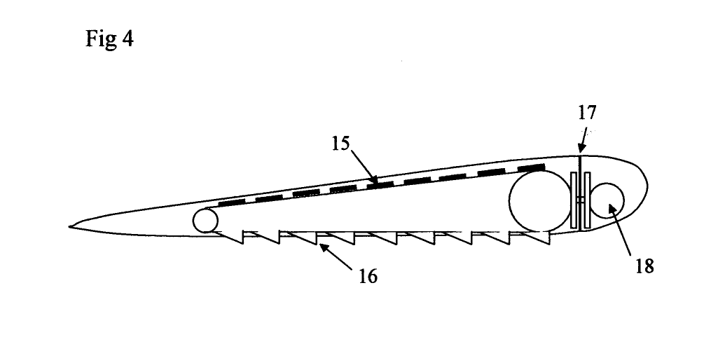

With reference to FIG. 4 is shown a schematic outlining the inner workings of the hydrodynamic design. The structure shows two cylindrical structures upon which is mounted a flexible membrane belt comprising pockets (16). In different embodiments these pockets may be rigid or they may be collapsible. In FIG. 4 is shown pockets in a collapsed state (15) as they return. A watertight bulkhead (17) separates the moveable membrane belt from the power generation means (18). The power generation means (18) may comprise a hydraulic pump which pumps fluid via a separate hydraulic line, comprising a send and return line, to a pump on board the marine vessel which drives an electric generator. Alternatively, the power generation means may comprise a mechanical gearing which drives an electric generator directly wherein the power from the generator is transmitted directly to the marine vessel via an electric cable.

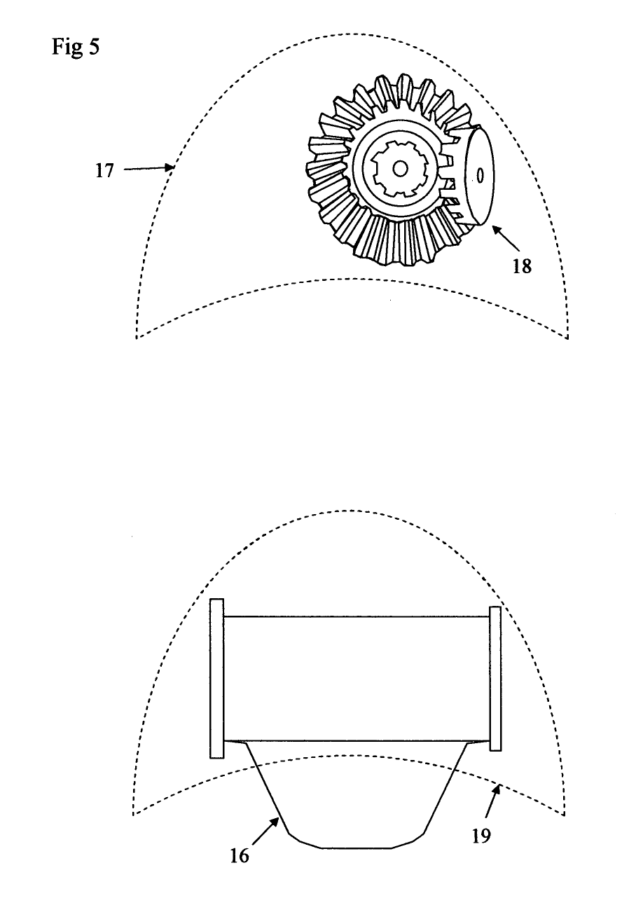

With reference to FIG. 5 is shown a simple gearing structure which may be employed within the bulkhead. The dotted line (17) shows the form of the bulkhead and in this example the power generation means comprises a gearing (18) which drives an electric generator (not shown).

In the lower part of FIG. 5 is shown the profile of a guiding structure (16) which in one embodiment runs the length of the hydrodynamic structure and which serves to form a channel open at the front and back and which guides fluid to the pockets of the flexible membrane belt. The underside of the hydrodynamically-shaped structure has a concave or raised arch form (19) which serves to facilitate surface contact between the fluid and the belt pockets thereby maximizing energy transfer.

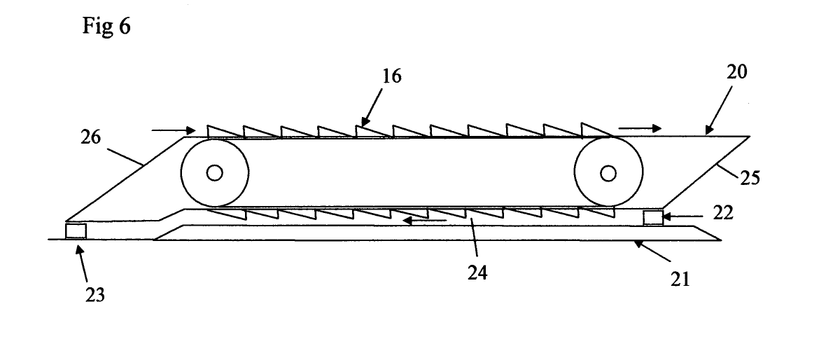

The invention also has direct application to power generation in tidal zones. FIG. 6 shows one embodiment of the invention which can generate power from incoming or outgoing tides. In the figure is shown a single belt system, although separate belt systems may be used for the lower and upper power generation systems. In this embodiment, a tidal zone barrier (20) is shown comprising a raised guide structure (21).

The orientation of the structure and the width of the flexible membrane belts are variables of design which will be chosen according to the fluid flow conditions of the specific tidal zone. The tidal zone structure will be manufactured from appropriate materials such as concrete. The height of the guide structure (21) and the separation in height between the top of the structure and the lower channel will also be chosen according to the tidal conditions of the specific location.

In one embodiment, incoming tides pass through one-way valve (22) thereby driving water through the lower channel (24) and out one-way valve (23). The structure comprises sloping sides (25,26) which serve to guide the fluid flow into the structure (25) or over the structure (26).

In different embodiments the flexible membrane belt may comprise rigid paddles or rigid pockets. Alternatively, separate belt systems may be linked to only one channel, or in the case of the upper part of the tidal zone barrier, only one area of surface fluid flow. Furthermore, the invention anticipates and includes the application of many separate belt systems which drive separate transmissions at different rates. This facilitates the changing and dynamic nature of the tidal fluid flow which can be moving in different directions even though the tide may be coming in or going out. Hydraulic transmission is ideally suited to combine the power generated by separate belt systems.

In other embodiments the tidal zone barrier may comprise additional control means wherein the one-way valves of the lower channel are maintained closed until a large volume of water from an incoming tide is held behind the structure. At a certain moment when sufficient water exists behind the structure, the one-way valves are opened and the head of water forces water into the lower channel (24).

These particular embodiments of the use of a flexible membrane belt to generate power are given as examples only.

In different embodiments the pockets or paddles on the membrane belt structure may comprise asymmetrical shapes, and be spaced apart with a regular spacing or with an irregular spacing.

It should be understood however, that the present disclosure is for the purpose of illustration only and does not include all modifications or improvements obvious to the man skilled in the art which may fall within the scope of the appended claims.

What is claimed is:

1. A system for generating electric power from fluid flow comprising:
a flexible membrane belt comprising at least one of pockets and paddles mounted on two or more cylindrical elements being caused to rotate by the movement of said membrane, wherein said membrane being dragged along by a moving fluid wherein
at least one of said cylindrical elements or being coupled to a transmission system for driving an electric generator, and
a flotation structure for maintaining said cylinders or cylindrical elements at an optimum height with respect to said moving fluid.

2. A system for generating electric power from fluid flow according to claim 1 wherein;
said two or more cylindrical elements being of identical or different diameters in order to maintain the lower part of the belt in optimum contact with the fluid flow, and being supported on two base structures made of a material of appropriate density placed on at least one of a river bed and another submerged structure.

3. A system for generating electric power from fluid flow according to claim 2 wherein;
each of said base structures further comprising vertical supports each carrying a moveable element enabling each of said cylindrical elements to move up or down along a vertical axis further maintaining the lower part of the belt at an optimum height with respect to the fluid surface, wherein
said optimum height being determined by the optimum power generation of said system wherein the at least one of paddles and pockets of said belt being immersed into the moving fluid thereby minimising the resistance to said belt motion, and
said moveable elements further comprising guide supports fixed to said flotation device and integrated with said system.

4. A system for generating electric power from fluid flow according to claim 3 wherein said vertical supports further comprising:
a fixing point at the top of a linking structure through which one or more fixing lines being attached, and wherein
the other end of each fixing line being fixed to the river or stream bed or the system being tethered to banks of a river or stream, and
the fixing lines for anchoring said system for generating electric power from fluid flow in places where said river being very deep or unsuitable for said base structures.

5. A system for generating electric power from fluid flow according to claim 1 wherein;
said system being supported by a flotation structure and said flotation structure further being made of low density material, and
said cylindrical elements being attached to two structures each comprising a vertical support by way of two rigid moveable support arms one on each side of said cylinder belt system and connected via a rod linking the two axis points for maintaining the tension on said belt while maintaining the inter-axial separation of said cylinders, and said vertical supports being further fixed to said flotation system, wherein said flotation system further includes at least one selected from the group consisting of a submerged guide plate or race, and opening vanes for guiding the water into the channel directly below said belt.

6. A system for generating electric power from fluid flow comprising:
a ray shaped hydrodynamic structure further comprising one or more wing structures, wherein
said structure being constructed of a material of appropriate low density for maintaining said structure at the optimum depth in the water, and
said wing structures for maintaining said structure at an optimum orientation and/or depth, and
a flexible moveable membrane belt comprising at least one selected from the group consisting of pockets and paddles mounted on two cylindrical elements being caused to rotate by the movement of said membrane belt, wherein
one of said cylindrical elements being coupled to a transmission system for driving an electric generator.

7. A system for generating electric power from fluid flow according to claim 6 wherein;
said structure being secured to the seabed or riverbed at the optimum depth for said power generation system generating power from submerged currents or rip currents, and
said structure further comprising a ring for attaching said structure to a marine vessel for towing or for dragging said structure through the water by said marine vessel.

8. A system for generating electric power from fluid flow according to claim 7 further comprising:
a watertight bulkhead separating said moveable membrane belt from said electric power generation system, and wherein
said power generation system further comprising at least one selected from the group consisting of:
(i) a hydraulic pump for pumping fluid via a separate hydraulic line, comprising a send and return line, to a pump on board said marine vessel for driving an electric generator,
(ii) a mechanical gearing for driving an electric generator directly wherein the power from said generator being transmitted to said marine vessel via an electric cable, and
(iii) electric cables connecting said power generation system to equipment on board of said marine vessel or on shore
wherein the power generated being be used to power lights on said structure for undersea lighting applications.

9. A system for generating electric power from fluid flow according to claim 8 wherein said ray shaped hydrodynamic structure further comprising:
a guiding structure running the length of said hydrodynamic structure for forming a channel open at the front and back for guiding fluid to the pockets of said flexible membrane belt, and
an arch form serving to facilitate surface contact between the fluid and the belt pockets for maximizing energy transfer.

10. A system for generating electric power from fluid flow comprising:
a tidal zone structure wherein said system generating power from incoming or outgoing tides further comprising;
one or more flexible moveable membrane belt systems comprising at least one of pockets and paddles mounted on two cylindrical elements being caused to rotate by the movement of said membrane belt, wherein
one of said cylindrical elements being coupled to a transmission system for driving an electric generator, and
a tidal zone barrier comprising a raised guide structure wherein
the orientation of said guide structure and the width of said flexible membrane belts being chosen according to the fluid flow conditions of said specific tidal zone.

11. A system for generating electric power from fluid flow according to claim 10 wherein;
said tidal zone structure being manufactured from appropriate materials and wherein
the height of said guide structure and the separation in height between the top of the structure and the lower channel being chosen according to the fluid flow conditions of said specific tidal zone.

12. A system for generating electric power from fluid flow according to claim 11 wherein;
said tidal zone structure further comprising a one-way valve wherein
incoming tides passing through said one-way valve thereby driving water through the lower channel and out via a one-way valve, and
said structure comprising sloping sides for guiding the fluid flow into the structure for an incoming tide or over the structure for an ebb tide,
said tidal zone barrier further comprising additional control means.

13. A method for generating electric power from fluid flow comprising:
dragging a flexible membrane belt comprising at least one of pockets and paddles mounted on two or more cylindrical elements by a moving fluid,
causing said cylindrical elements to rotate by the movement of said membrane belt,
maintaining said cylindrical elements at the optimum height with respect to said moving fluid by a flotation structure, and
coupling at least one of said cylindrical elements to a transmission system for driving an electric generator.

14. A method for generating electric power from fluid flow according to claim 13 wherein;
said two or more cylindrical elements being of identical or different diameters in order to maintain the lower part of the belt in optimum contact with the fluid flow, and being supported on two base structures made of material of appropriate density placed on a river bed or on another submerged structure.

15. A method for generating electric power from fluid flow according to claim 14 further comprising:
enabling each of said cylindrical elements to move up or down along a vertical axis,
immersing said pockets of said belt into the moving fluid thereby minimising the resistance to said belt motion,
determining said optimum height by the optimum power generated by said electric generator, and
maintaining the lower part of the belt at said optimum height with respect to the fluid surface wherein each of said base structures further comprising vertical supports each carrying a moveable element further comprising guide supports fixed to said flotation device and integrated with said system for generating electric power.

16. A method for generating electric power from fluid flow according to claim 15 further comprising:
attaching one or more fixing lines to a fixing point at the top said vertical supports of the linking structure, and at least one selected from the group consisting of;
(i) fixing the other end of each fixing line to the river or stream bed or
(ii) tethering said system for generating electric power to the banks of a river or stream, and
(iii) anchoring said system for generating electric power by means of said fixing lines from fluid flow in places where said river being very deep or unsuitable for said base structures.

17. A method for generating electric power from fluid flow according to claim 13 further comprising:
supporting said system for generating electric power by a flotation structure wherein said flotation structure further being made of low density material, and
attaching said cylindrical elements to two structures comprising a vertical support by way of two rigid moveable support arms one on each side of said cylinder belt system, and
connecting said cylindrical elements by means of a rod linking the two axis points for
maintaining the tension on said belt while maintaining the inter-axial separation of said cylindrical elements, and
fixing said vertical supports to said flotation structure, wherein
said flotation structure further includes at least one selected from the group consisting of a submerged guide plate or race
and opening vanes for guiding the water into the channel directly below said belt.

18. A method for generating electric power from fluid flow comprising:
constructing a ray shaped hydrodynamic structure of a material of appropriate low density for holding said structure at the optimum depth in the water wherein
said structure further comprising one or more wing structures for maintaining said structure at an optimum orientation and or depth,
mounting a flexible moveable membrane belt comprising at least one of pockets and paddles on two cylindrical elements,
causing said two cylindrical elements to rotate by the movement of said membrane belt, and
coupling one of said cylindrical elements to a transmission system for driving an electric generator.

19. A method for generating electric power from fluid flow according to claim 18 further comprising at least one selected from the group consisting of:
securing said structure to the seabed or riverbed at the optimum depth for said power generation system generating power from submerged currents or rip currents, wherein securing the structure includes at least one of tethering and anchoring, and
attaching said structure by means of a fixing point on said structure to a marine vessel for towing or for dragging said structure through the water by said marine vessel.

20. A method for generating electric power from fluid flow according to claim 19 further comprising:
separating said moveable membrane belt from said electric power generation system by a watertight bulkhead, and at least one selected from the group consisting of:
(i) pumping fluid via a separate hydraulic line, comprising a send and return line by a hydraulic pump, to a pump on board said marine vessel for driving an electric generator by said power generation system, of
(ii) driving an electric generator directly by a mechanical gearing for transmitting the power from said generator to said marine vessel via an electric cable by said power generation system,
(iii) using the power generated to power lights on said ray shaped hydrodynamic structure for undersea lighting applications, and
(iv) connecting said power generation system to equipment on board of said marine vessel or on shore by electric cables.

21. A method for generating electric power from fluid flow according to claim 20 further comprising:
forming a channel open at the front and back for guiding fluid to the pockets of said flexible membrane belt of said ray shaped hydrodynamic structure by means of a guiding structure running the length of said hydrodynamic structure and
maximizing energy transfer by means of an arch form on said hydrodynamic structure for facilitating surface contact between the fluid and said belt pockets.

22. A method for generating electric power from fluid flow comprising:
generating power by means of said system for generating electrical power from incoming or outgoing tides forming a tidal zone structure wherein said step of generating power further comprising the steps of;
mounting one or more flexible moveable membrane belt systems comprising at least one of pockets and of paddles on two or more cylindrical elements,
causing said membrane belt movement to rotate one of said cylindrical elements being coupled to a transmission system for driving an electric generator, and
choosing the orientation of said guide structure and the width of said flexible membrane belts according to the fluid flow conditions of said specific tidal zone by means of a tidal zone barrier further comprising a raised guide structure.

23. A method for generating electric power from fluid flow according to claim 22 wherein;
said tidal zone structure being manufactured from appropriate materials wherein
the height of said guide structure and the separation in height between the top of the structure and the lower channel being chosen according to the fluid flow conditions of said specific tidal zone.

24. A method for generating electric power from fluid flow according to claim 23 further comprising:
driving water in a one-way valve through the lower channel and out a one-way valve by said tidal zone structure,
guiding the fluid flow into the structure for an incoming tide or over the structure for an ebb tide by means of sloping sides (25,26) of said structure, and
controlling said tidal zone barrier by additional control means.
